(19) United States
(12) Patent Application Publication
(10) Pub. No.: US 2011/0030616 A1
(43) Pub. Date: Feb. 10, 2011

(54) PRESSURE-ACTUATED MEMBER, IN PARTICULAR PAINT PRESSURE CONTROLLER OR COATING AGENT VALVE

(76) Inventors: Thomas Buck, Ingersheim (DE); Michael Baumann, Flein (DE); Rainer Melcher, Oberstenfeld (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/864,115

(22) PCT Filed: Jan. 21, 2009
(86) PCT No.: PCT/EP09/00356

§ 371 Date: Aug. 13, 2010

(30) Foreign Application Priority Data
Jan. 22, 2008 (DE) DE102008005492.5

(51) Int. Cl. B05C 11/00; G05D 16/18; B23P 6/00; B23P 15/00

(52) U.S. Cl. 118/692; 137/511; 29/890.121; 29/890.12

(57) ABSTRACT

A pressure-actuated member, for example a paint pressure controller or a coating agent valve, for influencing a mean coating agent pressure of a coating agent to be applied in a painting system, is disclosed. An exemplary pressure-actuated member may comprise a component, which is subjected directly to the coating agent during operation and is mobile and/or can be deformed to influence the pressure. Examplary components subjected to the coating agent may at least partially comprise a ceramic material in order to achieve a longer service life.

### CROSS-REFERENCE TO RELATED APPLICATIONS

This application is a National Stage application which claims the benefit of International Application No. PCT/EP2009/000356 filed Jan. 21, 2009, which claims priority based on German Application No. 10 2008 005 492.5, filed Jan. 22, 2008, both of which are hereby incorporated by reference in their entirety.

### FIELD

The present disclosure relates to a pressure control member, for example a paint pressure regulator or a coating agent valve, for influencing a coating agent pressure of a coating agent to be applied in a painting installation.

### BACKGROUND

Paint pressure regulators are known, for example from EP 1 376 289 A1, and may be used to set a predefined coating agent pressure in a painting installation. Known paint pressure regulators may include a paint chamber having a paint inlet and a paint outlet, wherein a spring-loaded intake valve is arranged in the paint inlet, which intake valve closes the paint inlet in the rest state. One known paint pressure regulator comprises a control air chamber which immediately adjoins the paint chamber and which is separated from the paint chamber by a flexible membrane. An adjustable control air pressure is applied to the control air chamber during operation and acts on the membrane between the control air chamber and the paint chamber, so that the membrane deforms as a function of the pressure difference between the paint chamber and the control air chamber. For actuating the intake valve, the membrane has in its centre an actuating mandrel which can open the intake valve in the event of a pressure-induced deformation of the membrane.

If the paint pressure in the paint chamber falls below a predefined nominal value, the control air pressure in the control air chamber exceeds the paint pressure in the paint chamber. As a result, the membrane with the actuating member which is located between the control air chamber and the paint chamber is deflected in the direction of the intake valve and thus opens the intake valve. Once the intake valve has been opened, paint flows into the paint chamber, as a result of which the pressure in the paint chamber increases until the pressure in the paint chamber corresponds to the predefined nominal value, whereupon the intake valve then closes. The membrane between the control air chamber and the paint chamber is frequently deformed during operation of the paint pressure regulator and is therefore made from an elastic material, such as for example polytetrafluoroethylene (PTFE).

However, one disadvantage of the known paint pressure regulator described above is the low resistance to wear of the membrane and of the intake valve, which has a disruptive effect in particular when use is made of paints having a high solids content and/or containing abrasive paint ingredients. The service life of the membrane and of the sealing seat of the intake valve thus sometimes lies only in the range from one to two weeks, which means that frequent replacement of components is necessary.

Another disadvantage of the known paint pressure regulator described above lies in the fact that the intake valve requires a separate seal.

The object of the present disclosure is therefore to improve the paint pressure regulator described above. In particular, it is desirable to increase the service life of components, e.g., membrane and valve seat, that are susceptible to wear and/or to reduce the number of components. Furthermore, it is desirable that the paint pressure regulator reliably closes when no external pressure is applied.

### BRIEF DESCRIPTION OF THE FIGURES

Various exemplary illustrations are explained in detail below, with reference to the figures. In the figures:

FIG. 1 shows a cross-sectional view of a paint pressure regulator according to an exemplary illustration comprising a membrane and a valve seat made from a ceramic material, and

FIG. 2 shows another example of a paint pressure regulator comprising a return mechanism for the membrane.

### DETAILED DESCRIPTION

The present disclosure generally includes the technical realisation that the components (valve seat and membrane) which are susceptible to wear in the case of the conventional paint pressure regulators withstand the deformations which occur during operation but are damaged by paints having a high solids content and/or containing abrasive paint ingredients.

The exemplary illustrations therefore encompasses the general technical teaching of making the components (e.g. valve seat, membrane) which are susceptible to wear on a pressure control member (e.g. paint pressure regulator or coating agent valve) at least partially from a ceramic material which can better withstand the abrasive paint ingredients, this advantageously leading to an increased service life and to a much less frequent replacement of the components which are susceptible to wear.

The use of a ceramic material to produce the membrane has until now not been considered since ceramic materials are generally relatively brittle and therefore would ordinarily be expected to fail relatively quickly under the deformations which frequently occur during operation. In the context of the exemplary illustrations, therefore, use may be made of a ceramic fibre composite material which also offers sufficient permanent deformability and/or elasticity.

Such a fibre composite material may contain for example fibres made from carbon, silicon carbide or aluminium oxide, e.g., Al₂O₃, and a matrix made from silicon carbide or aluminium oxide.

Furthermore, the fibre composite material may have for example a two-dimensional or a three-dimensional matrix structure.

Ceramic material used in the exemplary illustrations may have an elongation at break of more than 0.2%, 0.5%, 1% or even more than 2%, so that the membrane can deform during operation without being destroyed. The ceramic material may behave substantially elastically up to its elongation at break, so that the membrane automatically returns to its initial or undeflected position.

It is already clear from the above description that the pressure control member according to the exemplary illustrations may be a paint pressure regulator, as described in a similar form in the patent application EP 1 376 289 A1, the contents of which are hereby expressly incorporated by reference in their entirety. However, exemplary pressure control members may alternatively also be, merely as examples, a coating agent valve or some other pressure control member.

Where the exemplary pressure control member is a paint pressure regulator, the paint pressure regulator may comprise a paint chamber having a coating agent inlet and a coating agent outlet, wherein an intake valve controls the supply of coating agent through the coating agent inlet into the paint chamber. Furthermore, the paint pressure regulator may comprise a control air chamber to which a control air pressure can be applied in order to set the coating agent pressure, wherein the control air pressure in the control air chamber determines the nominal value of the coating agent pressure. A membrane which, as a function of its membrane position, actuates the intake valve of the paint chamber may be arranged between the control air chamber and the paint chamber.

If the coating agent pressure in the paint chamber drops below the predefined control air pressure, the membrane located between the control air chamber and the paint chamber may be deflected in the direction of the paint chamber so that the membrane, or an actuating member attached to the membrane, opens the intake valve, whereupon coating agent flows into the paint chamber and increases the coating agent pressure in the paint chamber.

Once the coating agent pressure in the paint chamber has then risen to generally equalize the control air pressure in the control air chamber, the membrane is returned to its initial position, whereupon the intake valve in the inlet of the paint chamber is closed.

In this way, the paint pressure regulator—as described in detail in EP 1 376 289 A1—sets the coating agent pressure to a nominal value which is predefined by the control air pressure in the control air chamber.

The membrane may advantageously be made at least partially from the ceramic material in order to be able to withstand abrasive paint ingredients for as long as possible.

In addition, the intake valve may be made at least partially from a ceramic material in order to increase the service life.

In one exemplary illustration, the intake valve of the paint chamber comprises a valve ball and a valve seat, wherein the valve ball and/or the valve seat are made at least partially from the ceramic material.

Manufacturing the valve seat from a ceramic material offers the advantage that the intake valve need not have a separate seal, in particular no sealing ring made from rubber or plastic.

In one exemplary paint pressure regulator, the membrane located between the control air chamber and the paint chamber is movable between an open position and a closed position, wherein the membrane opens the intake valve in the open position, whereas the membrane does not open the intake valve in the closed position, so that the intake valve is then closed. A return mechanism may be provided which returns the membrane from the open position to the closed position when the control air pressure and/or the coating agent pressure do not bring about any other membrane position. The return mechanism offers the advantage that the paint pressure regulator, when no pressure is applied, assumes a defined position in which the paint pressure regulator is closed. In this regard, it must be noted that the exemplary illustrations also include a conventional pressure control member having the above-described return mechanism, e.g., a paint pressure regulator having a conventional membrane made from PTFE, merely as one example, and a conventional intake valve according to EP 1 376 289 A1.

The return mechanism may also comprise a return spring which acts on the membrane.

The return spring may be supported at one side, for example, against a stationary housing part, while the return spring is supported at the opposite end against an actuating member which is centrally attached to the membrane.

There are numerous possibilities with regard to the structural design of the return spring. Merely by way of example, the return spring may be configured as a coil spring, disc spring, plate spring or pressure spring, wherein the pressure spring may be integrated in the membrane.

An exemplary pressure control member may be designed in such a way that a service life of more than two weeks, one month, six months or one year is achieved in continuous operation if the coating agent is a liquid paint having a solids content of more than 50%, 60%, 70%, 80% or 90%.

It should also be mentioned that the exemplary illustrations encompass not only the above-described pressure control member as an individual part but also a painting installation comprising at least one such pressure control member.

In addition, the present disclosure also encompasses operating methods for a painting installation comprising an exemplary pressure control member, wherein the component (e.g. membrane, valve seat) of the pressure control member which is exposed to the coating agent and which is susceptible to wear is replaced after a given service life due to an abrasive effect of the coating agent. The exemplary operating methods may be generally characterised in that the service life of the component is more than two weeks, one month, six months or one year, so that the component (e.g. membrane, valve seat) which is susceptible to wear is accordingly rarely replaced.

Finally, the exemplary illustrations also encompass the novel use of a ceramic material to produce a component of a pressure control member of a painting installation, said component being exposed to a coating agent and being movable and/or deformable for pressure influencing purposes.

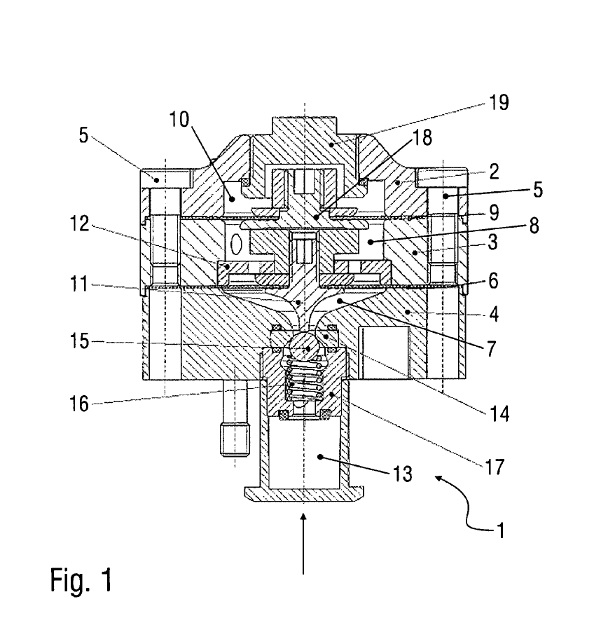

Turning now to FIG. 1, an exemplary paint pressure regulator 1 for setting a coating agent pressure in a painting installation is illustrated.

The paint pressure regulator 1 may, in some respects, such as the design and functioning of the paint pressure regulator 1, generally correspond to conventional paint pressure regulators, which are described for example in the patent application EP 1 376 289 A1, the content of which is fully incorporated by reference in its entirety.

The paint pressure regulator 1 may includes three housing components 2, 3, 4 arranged one above the other, which are fixedly connected to one another by screws 5.

A membrane 6 made from a ceramic fibre composite material may be located between the housing component 3 and the housing component 4, wherein the membrane 6 separates a paint chamber 7 from a control air chamber 8.

Located between the housing component 2 and the housing component 3 may be a further membrane 9 which may likewise be made from a ceramic fibre composite material and which separates the control air chamber 8 from a barrier air chamber 10.

Located in the centre of the membrane 6 is a hole, in which an actuating mandrel 11 may be arranged, wherein the technical significance of the actuating mandrel 11 will be described in more detail below.

In the control air chamber 8, an annular stop plate 12 may be inserted in the housing component 3, wherein the stop plate 12 generally delimits the movement clearance of the actuating mandrel 11 and thus also of the membrane 6 in the upward direction. This means that the actuating mandrel 11 can move upwards only as far as into the position shown in the drawing, in which the actuating mandrel 11 then butts against the stop plate 12.

The paint pressure regulator 1 also may have a coating agent inlet 13, via which coating agent can flow into the paint chamber 7.

Arranged in the coating agent inlet 13 may be an intake valve which essentially consists of a valve seat 14, a valve ball 15, a valve spring 16 and a valve housing 17. The valve spring 16 presses the valve ball 15 into the valve seat 14 with a given spring force, so that the intake valve leading to the paint chamber 7 is closed in the rest state.

The paint pressure regulator 1 also may have a coating agent outlet, via which the coating agent to be applied can flow at the desired coating agent pressure out of the paint chamber 7, wherein the coating agent outlet cannot be seen in the drawing.

Finally, the barrier air chamber 10 also may have a compressed air connection (not shown for the sake of simplification) for applying a barrier air pressure to the barrier air chamber 10, as will be described in more detail below. The membrane 9 between the barrier air chamber 10 and the control air chamber 8 likewise has a hole in the centre, in which an actuating member 18 may be arranged.

Finally, the upper housing component 2 may be closed, e.g., by a cover 19 which is screwed into the housing component 2 from below, wherein the intermediate space between the cover 19 and the housing component 2 is sealed off by a sealing ring.

The mode of operation of the exemplary paint pressure regulator 1 shown will now be described below.

Firstly, a desired nominal value of the coating agent pressure may be predefined by setting the control air pressure in the control air chamber 8. Through holes in the stop plate 12, the control air pressure in the control air chamber 8 then acts on the membrane 6 between the control air chamber 8 and the paint chamber 7.

For as long as the coating agent pressure in the paint chamber 7 is below the control air pressure in the control air chamber 8, the control air pressure causes the membrane 6 with the actuating mandrel 11 to be deflected downwards. In doing so, the actuating mandrel 11 generally pushes the valve ball 15 out of the valve seat 14, as a result of which the intake valve opens. Coating agent flows into the paint chamber 7, as a result of which the coating agent pressure in the paint chamber 7 increases.

As soon as the coating agent pressure in the paint chamber 7 corresponds to the control air pressure in the control air chamber 8, the membrane 6 is no longer deflected downwards, as a result of which the intake valve of the paint chamber 7 closes. The flow of coating agent out of the paint chamber 7 then leads once again to a decreasing coating agent pressure in the paint chamber 7, until the decreasing coating agent pressure in the paint chamber 7 once again leads to an opening of the intake valve. In this way, the coating agent pressure in the paint chamber 7 may be regulated to the predefined nominal value.

Furthermore, the paint pressure regulator 1 allows an opening of the intake valve independently of the other pressure conditions, which is useful, for example during pigging. To this end, a sufficiently high barrier air pressure may be applied to the barrier air chamber 10, as a result of which the membrane 9 with the actuating member 18 is deflected downwards. The actuating member 18 then pushes the actuating mandrel 11 downwards until the valve ball 15 is pushed out of the valve seat 14, as a result of which the intake valve opens.

In the case of the paint pressure regulator 1, the two membranes 6, 9 and the valve seat 14 may be made from a ceramic fibre composite material. This offers the advantage that the membranes 6, 9 and the valve seat 14 can better withstand the abrasive paint ingredients, which leads to a much longer service life.

Another advantage lies in the fact that the valve seat 14 does not require for sealing purposes any separate sealing ring made from rubber or plastic, as is the case with the conventional paint pressure regulators.

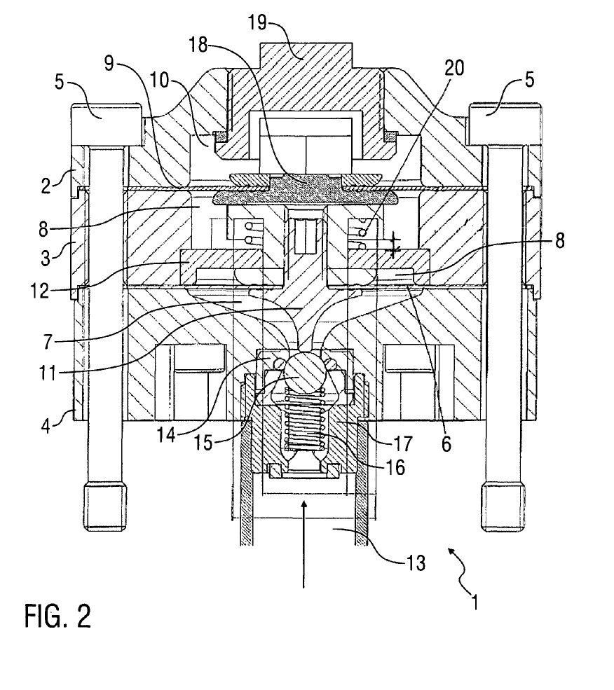

FIG. 2 shows another exemplary paint pressure regulator similar to that shown in FIG. 1 so that, in order to avoid repetitions, reference is made to the above description of the example of embodiment shown in FIG. 1, the same references being used for corresponding details.

One particular feature of the example shown in FIG. 2 lies in the fact that a return mechanism is provided which returns the actuating mandrel 11 and thus also the membrane 6 in the upward direction when no external forces are acting. To this end, the return mechanism comprises a return spring 20 which is supported at one side against the upper side of the annular stop plate 12 and at the other side against the actuating mandrel 11, so that the return spring 20 pushes the membrane 6 upwards into the stop position shown in the drawing.

In this example, the return mechanism generally ensures that the intake valve is closed when no external pressure is applied, so that no coating agent is dispensed.

Also in this example, the membranes 6, 9 and the valve seat 14 may be made from a ceramic fibre composite material, which is associated with the advantages described above.

However, it is also possible in this example that the membranes 6, 9 are made from a conventional material, such as PTFE for example.

Furthermore, in this example, the intake valve may also be formed in a conventional manner. The valve seat 14 may thus be made, merely as one example, from a thermoplastic material.

The exemplary illustrations are not limited to the examples described above. Instead, a large number of variants and modifications are possible which likewise make use of the concept of the invention and therefore fall within the scope of protection. Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be evident upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “the,” etc. should be read to recite one or more of the indicated elements unless a claim recites an explicit limitation to the contrary.

### LIST OF REFERENCES

1 paint pressure regulator
2-4 housing components
5 screws
6 membrane
7 paint chamber
8 control air chamber
9 membrane
10 barrier air chamber
11 actuating mandrel
12 stop plate
13 coating agent inlet
14 valve seat
15 valve ball
16 valve spring
17 valve housing
18 actuating member
19 cover
20 return spring

1.-16. (canceled)

17. A pressure control member for influencing a coating agent pressure of a coating agent to be applied in a painting installation, said pressure control member comprising a component which is directly exposed to the coating agent during operation, the component being movable for pressure influencing purposes, wherein the component which is exposed to the coating agent is made at least partially from a ceramic material.

18. The pressure control member according to claim 1, wherein the pressure control member is a coating agent valve.

19. The pressure control member according to claim 1, wherein the pressure control member is a paint pressure regulator.

20. The pressure control member according to claim 18, further comprising:
a paint chamber having a coating agent inlet and a coating agent outlet,
an intake valve configured to control the supply of coating agent through the coating agent inlet into the paint chamber,
a control air chamber configured to receive a control air pressure to set the coating agent pressure, wherein the control air pressure in the control air chamber determines the coating agent pressure, and
a membrane arranged between the control air chamber and the paint chamber and which, as a function of its membrane position, actuates the intake valve of the paint chamber.

21. The pressure control member according to claim 20, wherein the membrane is made at least partially from a ceramic material.

22. The pressure control member according to claim 20, wherein the intake valve is made at least partially from a ceramic material.

23. The pressure control member according to claim 20, wherein:
the intake valve of the paint chamber comprises a valve ball and a valve seat, and
the valve ball and the valve seat is made at least partially from a ceramic material.

24. The pressure control member according to claim 23, wherein the intake valve has no separate seal and no sealing ring.

25. The pressure control member according to claim 20, wherein
the membrane is movable between an open position and a closed position, wherein the membrane opens the intake valve in the open position, whereas the membrane does not open the intake valve in the closed position, and
a return mechanism is provided which returns the membrane from the open position to the closed position.

26. The pressure control member according to claim 25, wherein the return mechanism comprises a return spring which acts on the membrane.

27. The pressure control member according to claim 16, wherein
an actuating member configured to actuate the intake valve is centrally attached to the membrane, and
the return spring is supported at one side against the actuating member and at the other side against a stationary housing part.

28. The pressure control member according to claim 1, wherein the ceramic material is a ceramic fibre composite material.

29. The pressure control member according to claim 28, wherein the fibre composite material contains fibres.

30. The pressure control member according to claim 29, wherein the fibres are made from a material selected from the group consisting of carbon, silicon carbide, aluminium oxide, and Al₂O₃.

31. The pressure control member according to claim 28, wherein the fibre composite material contains a matrix made from silicon carbide or aluminium oxide.

32. The pressure control member according to claim 28, wherein the fibre composite material has a two-dimensional matrix structure.

33. The pressure control member according to claim 28, wherein the fibre composite material has a three-dimensional matrix structure.

34. The pressure control member according to claim 17, wherein the ceramic material has an elongation at break of more than 0.2%.

35. The pressure control member according to claim 17, wherein the ceramic material is substantially elastic up to the elongation at break.

36. The pressure control member according to claim 17, wherein
the coating agent is a liquid paint having a solids content of more than 50%, and
the pressure control member has a service life of more than 1 month in continuous operation with the coating agent.

37. A painting installation comprising at least one pressure control member according to claim 17.

38. A method for operating a painting installation, wherein the component of the pressure control member which is exposed to the coating agent is replaced after a given service life due to an abrasive effect of the coating agent on the component, wherein the service life of the component is more than 1 month.

39. A method, comprising using a ceramic material to produce a component of a pressure control member of a painting installation, said component being exposed to a coating agent and being movable and/or deformable for pressure influencing purposes.
